(19) United States
(12) Patent Application Publication
(10) Pub. No.: US 2003/0022138 A1
(43) Pub. Date: Jan. 30, 2003

(54) Self-service kiosk trainer

(76) Inventor: Aravinda Korala, Edinburgh (GB)

Correspondence Address: SALTAMAR INNOVATIONS, 30 FERN LANE, SOUTH PORTLAND, ME, 04106, US

(21) Appl. No.: 09/915,953

(22) Filed: Jul. 26, 2001

(51) Int. Cl. G09B 19/00

(52) U.S. Cl. 434/118

(57) ABSTRACT

The present invention provides a method for increasing the use by the public of self-service kiosks. In particular, on or adjacent to a self-service kiosk there is provided the URL of an online trainer or simulator facility that relates directly to the kiosk. This enables users to develop their confidence in such systems without any fear of accidentally causing unwanted outcomes.

### FIELD OF INVENTION

The present invention relates to the field of delivering web commerce through self-service kiosks. In particular it presents a trainer facility for web-enabled self-service kiosks such as automated teller machines, ticketing machines, vending machines, web kiosks and Internet enabled television set-top boxes with user interface peripherals.

### BACKGROUND

Self-service kiosks are networked computing devices designed for use by multiple users to carry out self-contained operations. Examples of such kiosks are automated teller machines (ATMs), public Internet access terminals, credit card operated and/or pre-paid ticket collection terminals, network ticket machines and computerised vending machines as these are designed for use by multiple users where each user's interaction with the kiosk is a separate self contained session. Home computers are not kiosks as users make open ended changes to such computers; however, they can emulate kiosks and personal computers can also be used to control kiosks. The present invention can also be applied to interactive television having the facility to emulate kiosks. These facilities would include user identifying means such as a smart card reader.

Recently, there has been a significant increase in the number of self-service kiosks, and related services, offered to the general public. Examples are discussed in recently filed U.S. patent application Ser. Nos. 09/870,293 and 09/870,057, the contents of which are incorporated herein by reference. These self-service kiosks access electronic pages over an Internet system via designated addresses.

The most common form of self-service kiosk still remains ATMs. However, ticket collection terminals, computerised vending machines etc. are becoming more common. The increasing range of services offered by self service kiosks can be somewhat off-putting to members of the public who tend to harbour initial concerns with regards such new technologies.

Such concerns manifest themselves in two main areas in relation to self-service kiosks. The first of these is in relation to payment procedures and in particular to the provision of credit/debit card details through e-commerce based applications. There is a general reluctance on behalf of the general public with regards to the making of such payments via self-service kiosks. This reluctance is primarily due to a lack of familiarity with such systems. Additionally, the fear of overspending by accidental multiple orders or the ordering of the wrong products aggravates the public's lack of confidence in such self service kiosk systems.

It would therefore be highly advantageous for members of the public to be given the opportunity to experiment with such self-service kiosks without having to actually go through with making a purchase. This would help increase customer confidence so lending them to more readily employ such self-service kiosks. Such an opportunity to experiment with self-service kiosks may also help in reducing a public fear of credit card fraud in e-commerce systems, thus again leading to an increased use of self-service kiosks.

The second area of concern to members of the public resides in an inherent dislike for change and for new technology. A consumer given the option between purchasing a ticket from a new self-service kiosk or from the more traditional manned ticket booth is likely to choose the latter due to a reluctance to approach the new technology. Adding to this reluctance is an embarrassment factor where members of the public do not wish to experiment with the new technology in case they make mistakes in the full view of others. Such reluctance grows in the presence of rush hour crowds and in particular where large queues have formed. Therefore, a member of the public is unlikely to experiment with a new self-service kiosk when they find themselves under pressure from others to finish using the kiosk. This likelihood of experimentation is further reduced in proportion to the number of other people in the vicinity of the kiosk.

The distrust in providing credit card details and anxieties raised in using such new technologies restricts the complexity of and services offered by such self-service kiosks. Provision of a method for overcoming such concerns would result in an increased use of such self-service kiosks while simultaneously allowing kiosk providers to increase the range of services on offer.

It is the aim of the present invention to provide an on-line trainer facility for a self-service kiosk that trains a user in how to operate the kiosk.

A further aim of the present invention is to provide an on-line simulation of a self-service kiosk that allows a user to familiarise themselves with the presentation and operating procedures of the kiosk.

### BRIEF DESCRIPTION OF THE INVENTION

According to the present invention there is provided A method of training a user of a self-service kiosk, the method comprising the steps of:

providing a self-service kiosk for providing a service to a user;

on or adjacent to the self-service kiosk, providing the address of an online training facility; and

providing at said address an online training facility instructing the user in the use of said self-service kiosk.

According to a second aspect of the present invention there is provided a method of training a user of a self-service kiosk, the method comprising the steps of:

providing a self-service kiosk for providing a service to a user;

on or adjacent to the self-service kiosk, providing the address of an online simulator; and

providing at said address an online simulator simulating the function of said self-service kiosk.

As discussed above the reluctance of a user to employ self-service kiosks reduces the usefulness of such devices. Therefore, the present invention provides means for a member of the public on approaching a self-service kiosk to obtain an address for both a trainer facility and a simulator. The trainer facility or simulator can then be accessed at a later time.

In particular the trainer facility provides a step by step guide and explanation to the self-service kiosk and all the facilities offered by it. Whereas the simulator provides a simulation of the self-service kiosk, without the step by step guide, such that the user can replicate directly the experience of being at the self-service kiosk.

### BRIEF DESCRIPTION OF THE DRAWINGS

An example embodiment of the present invention will now be illustrated with reference to the following drawings of which:

FIG. 1 is a schematic diagram of a self-service kiosk according to the present invention;

FIG. 2 represents an example screen display of the self-service kiosk;

FIG. 3 represents an example introduction screen display of a trainer user interface for the self-service kiosk;

FIG. 4 represents an example screen display for the first stage of the trainer user interface for the self-service kiosk;

FIG. 5 represents an example format error screen display corresponding to the first stage of the trainer user interface for the self-service kiosk;

FIG. 6 represents an example screen display for the second stage of the trainer user interface for the self-service kiosk;

FIG. 7 represents an example screen display for the third stage of the trainer user interface for the self-service kiosk;

FIG. 8 represents an example confirmation screen display of the trainer user interface for the self-service kiosk;

FIG. 9 represents an example screen display of a receipt of the trainer user interface for the self-service kiosk;

FIG. 10 represents an example conclusion screen display of a trainer user interface for the self-service kiosk;

FIG. 11 represents an example introduction screen display of a simulator user interface for the self-service kiosk;

FIG. 12 represents an example screen display of the simulator user interface for the self-service kiosk; and

FIGS. 13a and 13b represent example conclusion screen displays of the simulator user interface for the self-service kiosk.

### DETAILED DESCRIPTION OF THE PREFERRED EMBODIMENT

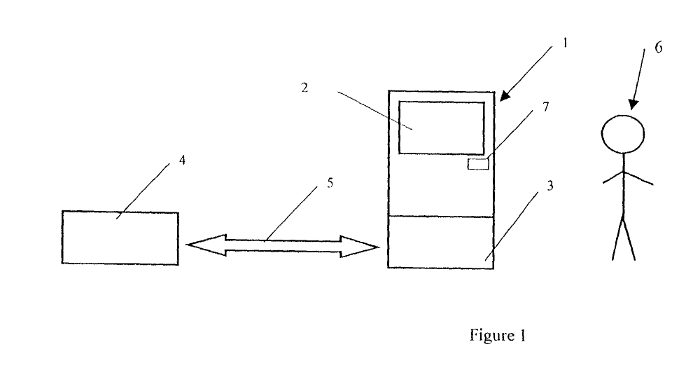

FIG. 1 illustrates a self-service kiosk 1 having a display 2 driven by a computer 3 that has access to one or more servers 4 across a network 5.

The self-service kiosks 1 have user interfaces for interaction with users 6. User interfaces may incorporate devices such as monitors, touch screens, keyboards, mouse, cash dispensers, card reading devices, identification devices such as number pads for inputting a pin number or cornea, iris or fingerprint readers.

Additionally, the self-service kiosk 1 provides a facility for providing a printed document 7 of the address of an online trainer or simulator facility that relate directly to the self-service kiosk 1. In the preferred embodiment, the address is the Uniform Resource Locators (URLs) of an Internet server, although alternative address systems might be employed for other networking systems.

In this embodiment, the hard copy 7 of the URLs is provided by a business card located in a holder on or adjacent to the self-service kiosk 1. Alternatively, it may be printed on a receipt that relates to the transaction carried out by the user 6. Business cards may have the URLs pre-printed on them. If a receipt is employed to provide the required URLs they may be pre-printed on the back or printed on demand by the user 6. As well as being provided on the self-service kiosk itself, a business card holder, not actually attached to the self-service kiosk 1, but instead located nearby, may equally well supply the hard copy 7.

Such hard copies 7 may include no other business details except for the required URLs.

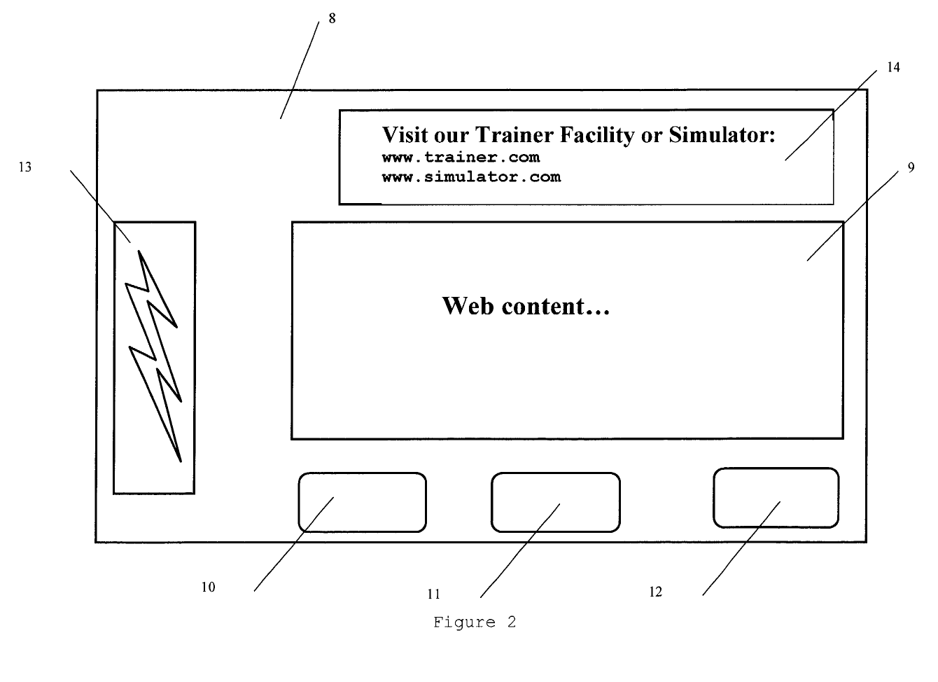

FIG. 2 illustrates an example screen view 8 of a typical self-service kiosk 1. The computer 3 executes a web browser, for example an Internet Explorer® browser available from Microsoft® of Redmond, Wash. The browser component controls a visible service window 9 that provides access for the user 6 to the services on offer from the provider. Web pages accessed by the browser may be stored locally within the computer 3 or more preferably on one or more servers 4 and so are accessed via the network 5. User interface components may include all types of information delivered through the Internet such as streamed video 10, audio 11 or animation 12 as well as a company logo 13. A service display 14 offers information regarding the trainer facility and simulator URLs and invites the user 6 to remove a hard copy 7 of the URLs, whether in the form of a business card or a receipt as previously described.

Having approached and observed the self-service kiosk 1 the user 6 may have concerns with regards to giving their credit card details or to their technical ability in working the self-service kiosk 1. On observing that the self-service kiosk 1 offers an on-line trainer facility and simulation facility the user 6 can take a hard copy 7 of the URLs. Thereafter, the user 6 may access the trainer facility and/or the simulator in their own time without the pressure of being observed by other queuing consumers. Therefore, since the self-service kiosk 1 provides URLs for on-line trainer facilities it allows the user 6 to learn how to efficiently employ the system in an environment of their choice.

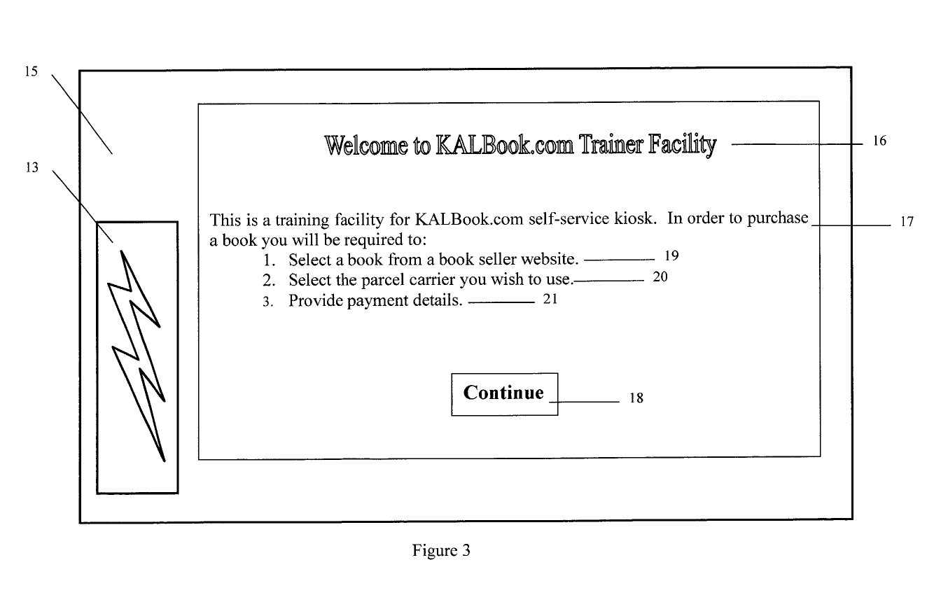

FIG. 3 illustrates a screen shot of an introductory page 15 of the trainer web page accessed via the trainer URL. This embodiment relates to a compound transaction that requires the user 6 to employ the self-service kiosk 1 to carry out multiple network interactions before the compound transaction can be authorised. However, compound transactions are just one example of the use to which a self-service kiosk 1 may be employed. Others uses include single step sales transactions from ticket or vending machines. In particular, the introductory page 15 guides the user 6 through the procedure relating to a self-service kiosk 1 that acts as an on-line book seller. The introductory page 15 comprises a title 16, a company logo 13, a brief explanation of the procedure involved 17 and a continuation button 18. The explanation of the procedure 17 outlines the steps required to be completed, namely:

1. Browse to select a book from a book seller website 19;

2. Browse a second website to select a parcel carrier to be used 20;

3. Browse a third website in order to authorise payment from an on-line banking facility 21.

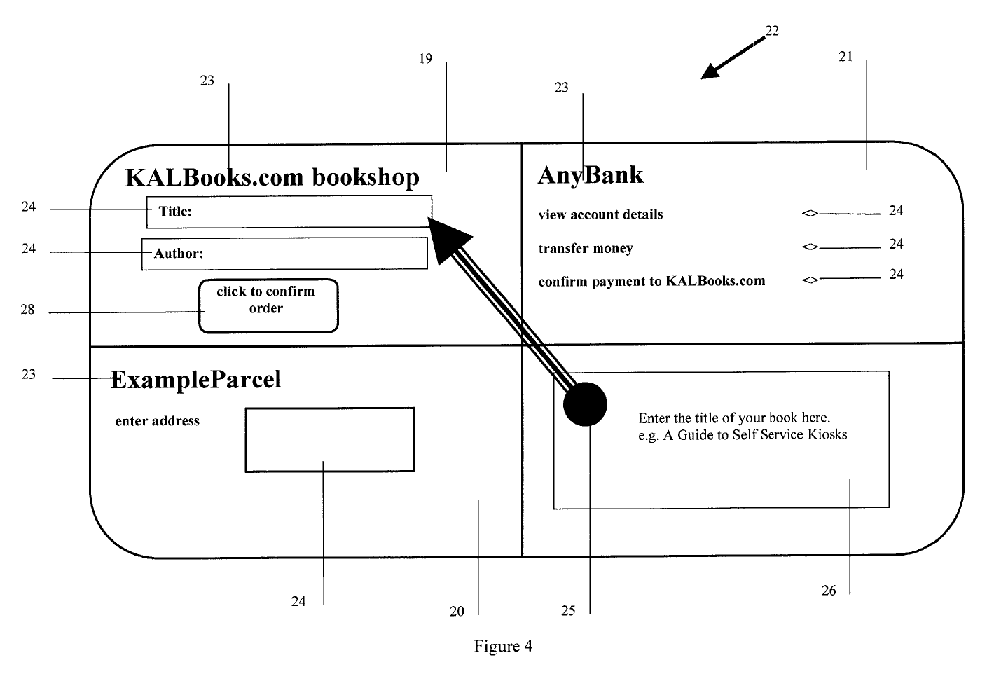

When the user 6 is ready to continue they are simply required to activate the continuation button 18. This transfers the user 6 to the first page of the trainer 22 as shown in FIG. 4.

The first page 22 can be seen to comprise of four sections, three of which 19, 20, and 21 correspond to the websites discussed in brief explanation of the procedure 17 outlined on the introductory page 15. Each section includes a section title 23 and one or more fields 24 that require completion by the user 6 in order to finalise the compound transaction.

Initially, a pointer 25 indicates the field 24 within which the title of the book has to be entered. A prompt window 26 explaining the required format for this field is also present. The user 6 is then required to complete the field 24 as instructed by the prompt window 26 before the trainer allows them to proceed to the next step which involves entering the book's author. The relevant fields 24 may readily incorporate drop down menus to aid the user 6 in their completion.

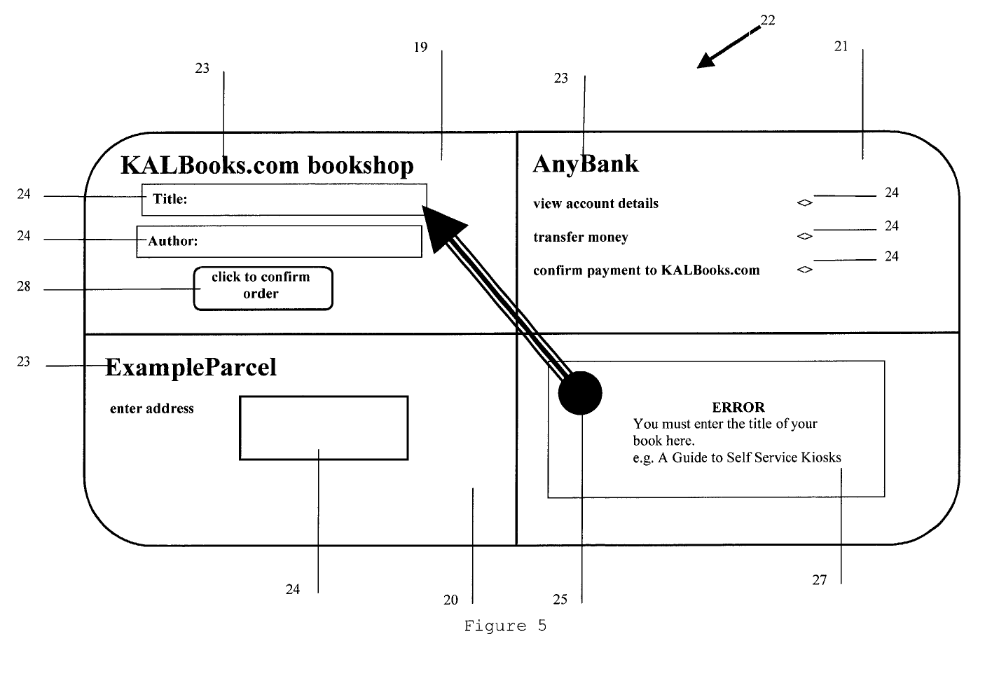

FIG. 5 represents the situation where the user 6 has entered the wrong format for a field 24, in this case the book title field. On detecting the incorrect format for a field 24 the trainer replaces the prompt window 26 with an error message window 27 that highlights the mistake and reiterates for the user 6 to insert the correct format within the field 24. The error message window 27 remains present until the user 6 inserts the correct format in the required field 24.

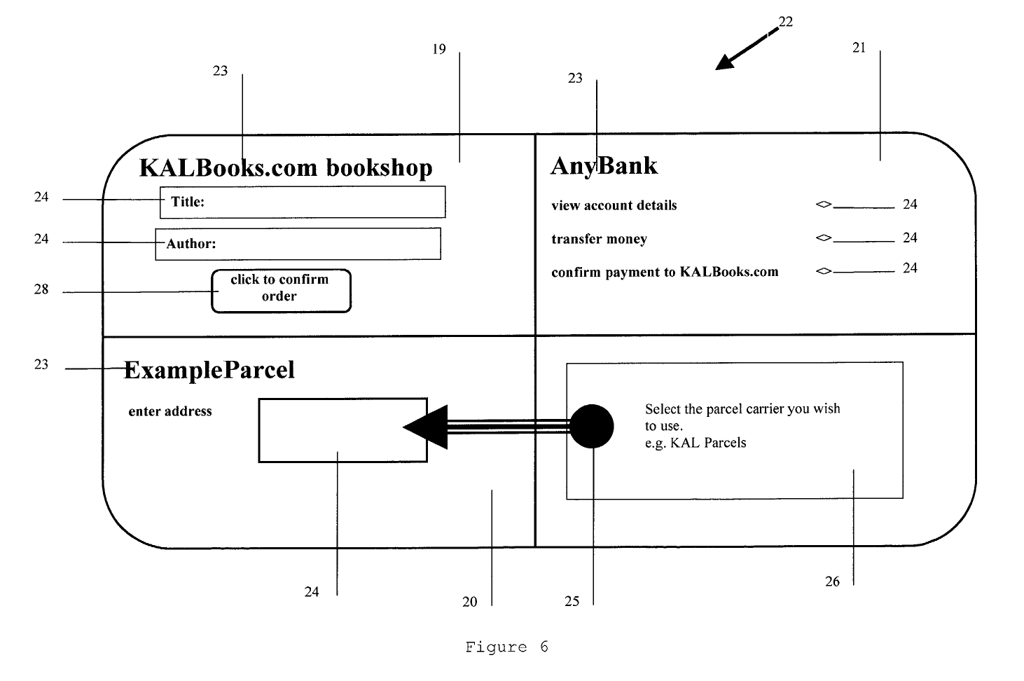

On correctly entering the required details in relation to the book the trainer then moves on to the website relating to the parcel carrier 20 as shown in FIG. 6. The pointer 25 and information within the prompt window 26 now relate to the field 24 that corresponds to the choice of parcel carrier. An error message window 27 will again replace the prompt window 26 if the user 6 does not complete this field 24 correctly.

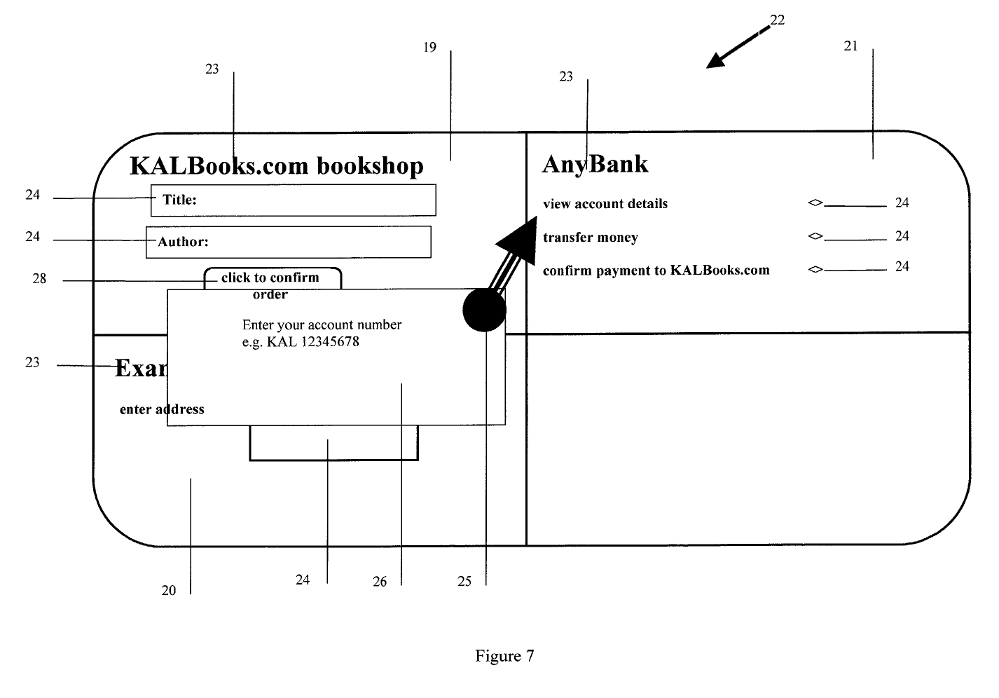

Once the parcel carrier has been selected the pointer 25 and prompt window 26 then move onto the third section 21 that relates to payment for the book and carrier services via an on-line banking facility, see FIG. 7. The combination of the pointer 25 and prompt window 26 then explain the location and format required in order to correctly deal with the payment for the selected book.

In an alternative embodiment of the trainer facility, relating to a self-service kiosk 1 that requires the user 6 to insert a credit card, the trainer facility displays a graphic illustrating a credit card. The trainer facility then require the user 6 to click the mouse over this graphic at the appropriate point in order to proceed with the transaction.

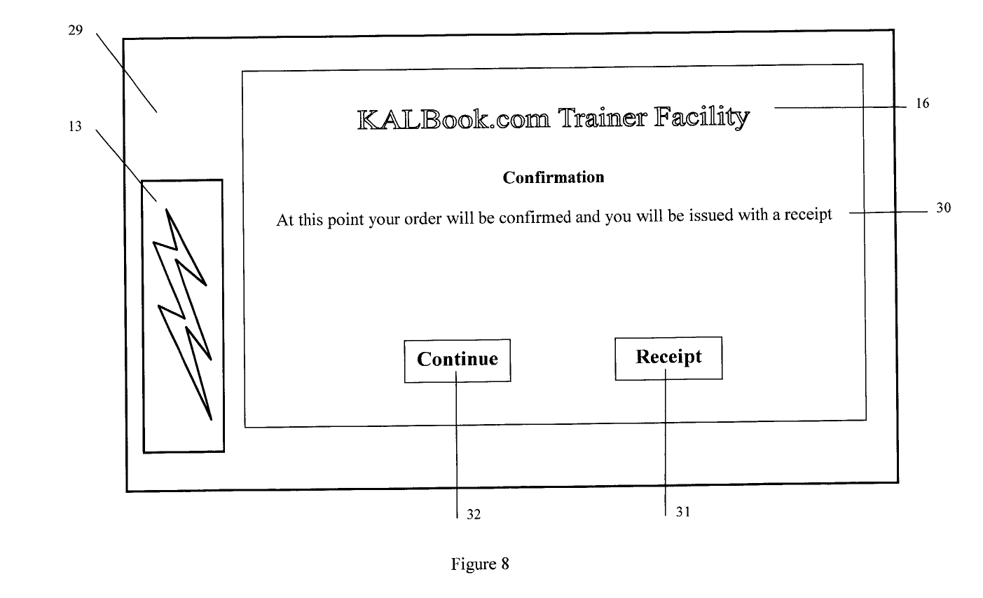

With all the required data correctly entered via three web pages 19, 20, and 21 the user 6 is then prompted to click to confirm their order 28. On confirming their order the user is then presented with a confirmation screen 29 as shown in FIG. 8. The confirmation screen can be seen to comprise a confirmation message 30 and options to either observe an associated receipt 31 or to continue 32.

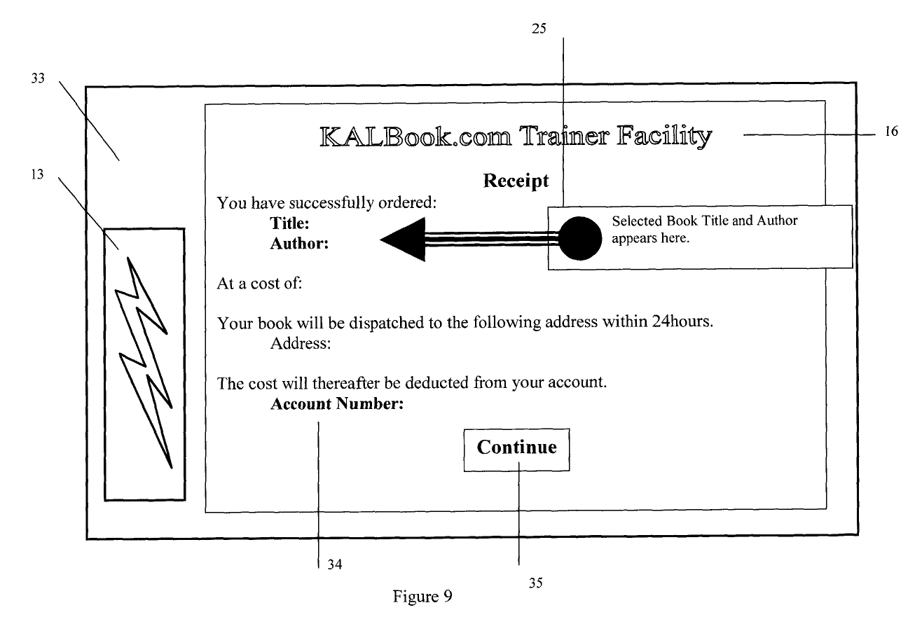

FIG. 9 presents a screen display of an example receipt 33. Here the pointer 25 and prompt window 26 leads the user through and provides an explanation of the contents of the receipt 34. When finished viewing the receipt the user is then prompted to continue 35.

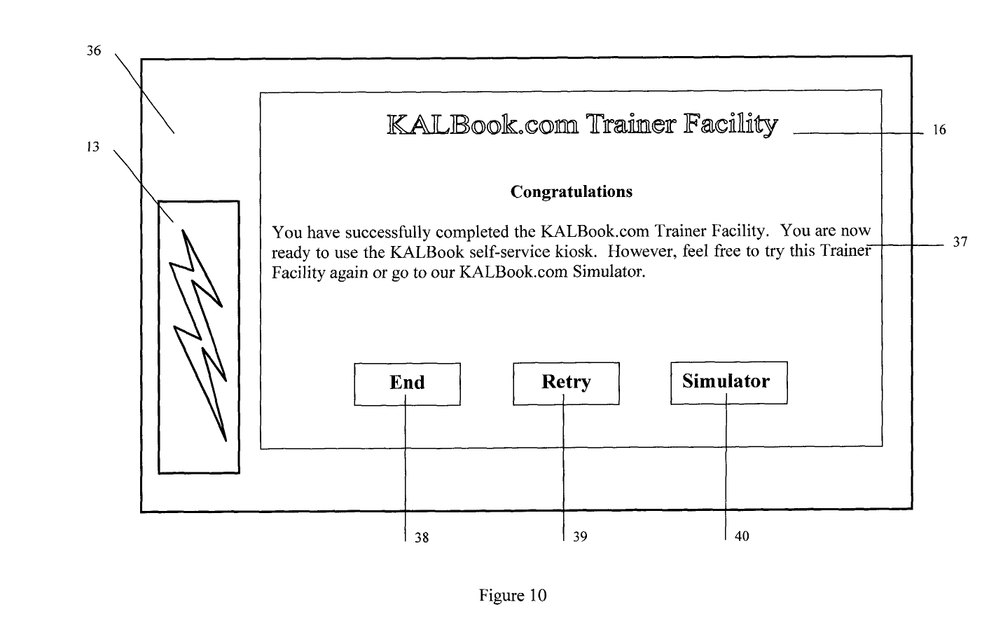

The trainer facility then presents a conclusion screen 36 to the user 6, an example of which is shown in FIG. 10. A message 37 is displayed explaining to the user 6 that they have successfully completed the trainer module and will now be able to use the self-service kiosk 1 in order to purchase books on-line. The user 6 is then presented with three options, namely:

1. Ending the trainer facility session 38;

2. Using the trainer facility again 39;

3. Moving from the trainer facility to a corresponding simulator 40.

Therefore, the user 6 can either end the session 38 or, if further training is desirable, use the trainer facility again 39 by returning to the introduction page 15. Alternatively, the user 6 may decide to transfer to related simulator 40. In effect the simulator button 40 moves the user 6 between the URL for the trainer facility for the self-service kiosk 1 and the relevant simulator (an example embodiment of a simulator is described below).

The present invention also provides an on-line simulator in addition to the trainer facility. The simulator acts to reproduce the self-service kiosk 1 without actually finalising the related transaction. As an example, if the simulator was to reproduce an ATM it may display graphics illustrating money being dispensed. Similarly, if the simulator was to reproduce a self-service kiosk 1 that requires the user 6 to insert a credit card, it then displays graphics illustrating the credit card and again require the user 6 to click the mouse over this graphic in order to proceed.

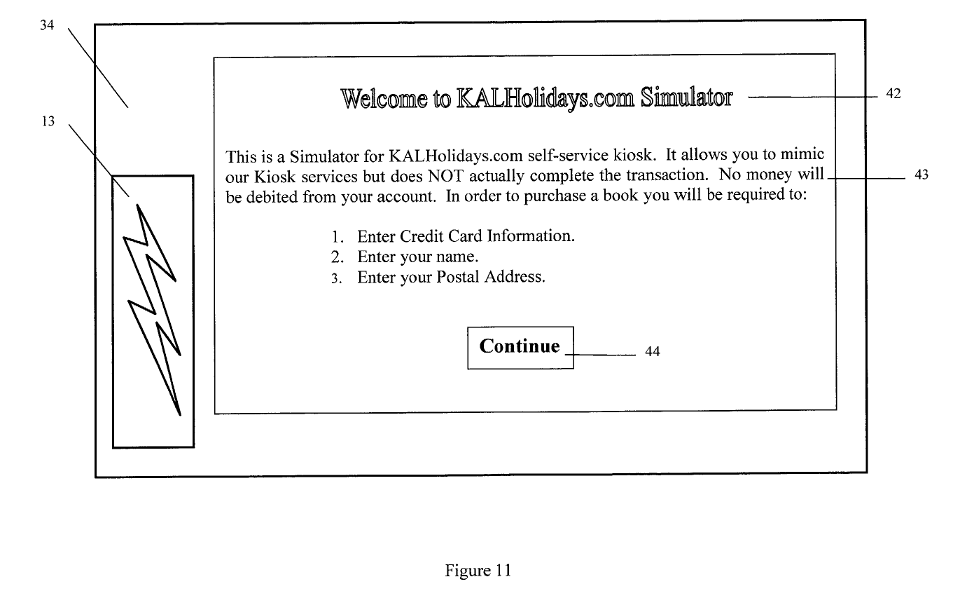

FIG. 11 illustrates a screen shot of the introduction page of a simulator 41 employed to implement a compound transaction. This simulator relates to a self-service kiosk 1 that provides a facility for booking a flight, a hotel and for ordering currency via web pages for foreign travel. The introduction page of the simulator 41 comprises a title 42, an explanation of the procedure involved 43, a logo 13 and a continuation button 44.

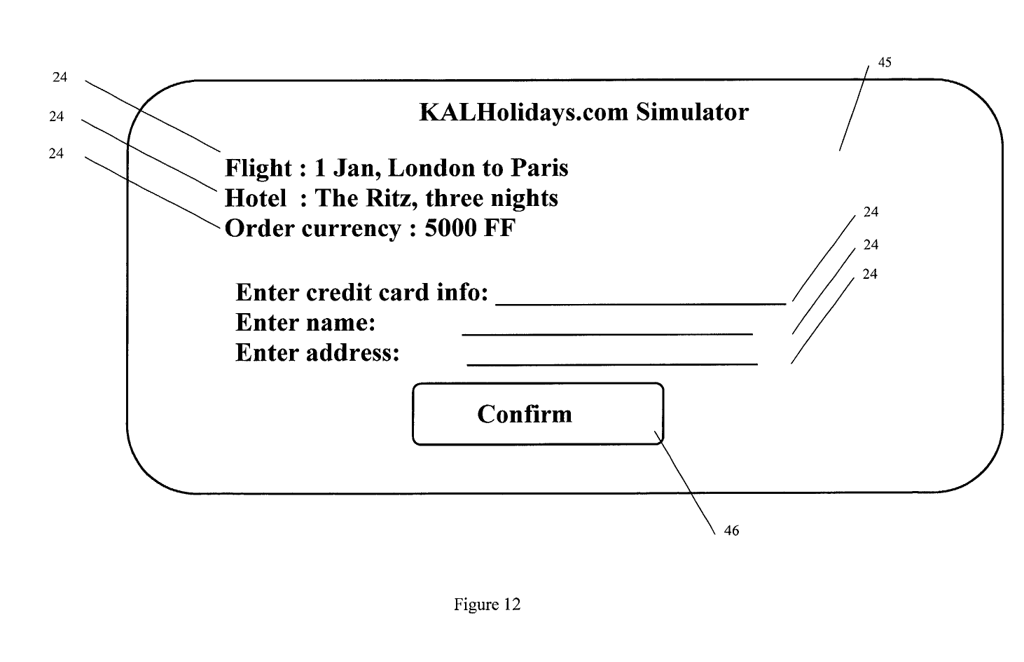

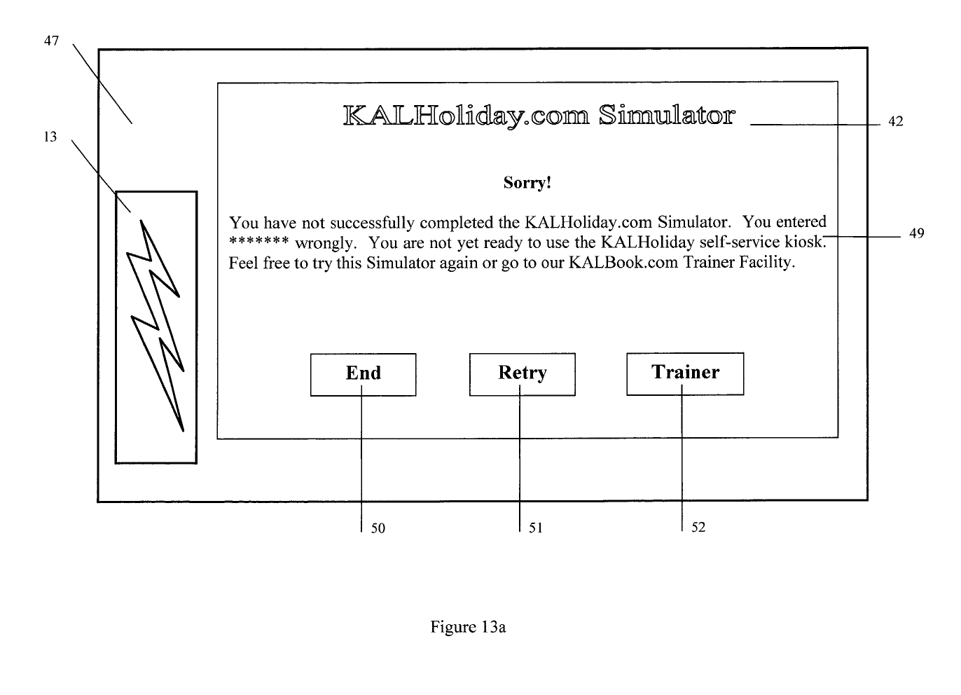

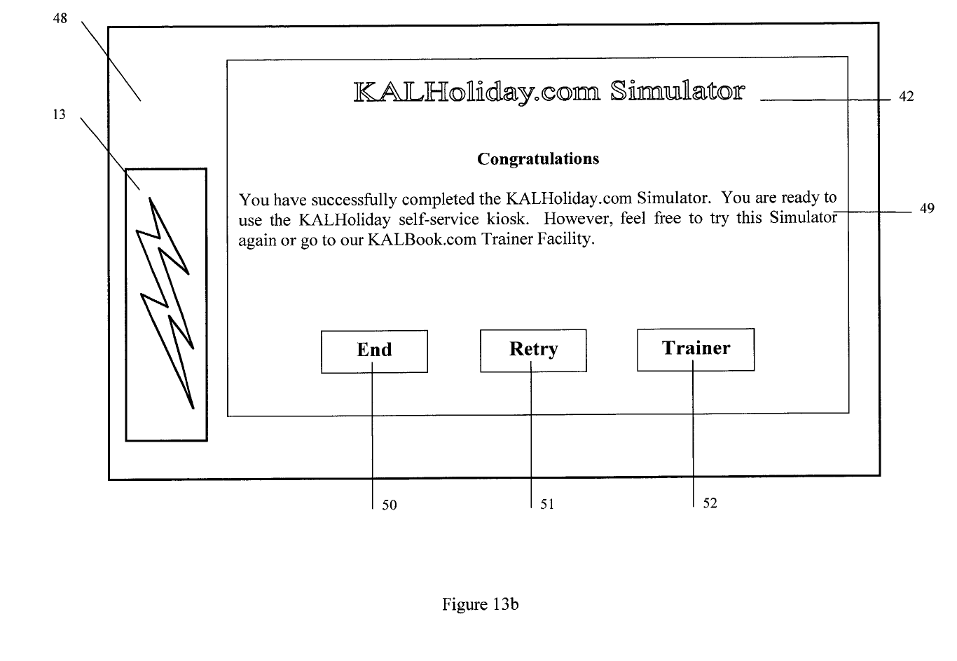

On choosing to continue 44 from the introduction page 41 the user 6 is presented with the simulation 45 of the self-service kiosk 1 without the aid of the pointer 25 or the prompt window 26, see FIG. 12. The user 6 is expected to enter information concerning their travel arrangements along with their credit card, name and address in the relevant fields 24. On activating the confirm button 46, the user 6 is presented with a conclusion page 47 or 48, as illustrated in FIG. 13, instead of the transaction actually being actioned as would be the case on the self-service kiosk 1.

FIG. 13(a) represents the conclusion page 47 corresponding to the scenario where the credit card, the name or the address details have not been entered in the correct format as required by the self-service kiosk 1. A message 49 is presented that highlights the field or fields that have been incorrectly entered, along with the correct format required in order to complete the transaction correctly. The user 6 is also presented with three options intended to finish the simulation session, namely:

1. Ending the simulator facility session 50;

2. Using the simulator facility again 51;

3. Moving from the simulator facility to the corresponding trainer 52.

FIG. 13(b) presents the conclusion page 48 where the user 6 has successfully completed the foreign travel simulator. In this instance, the user 6 is presented with a message 49 notifying them of their success. The three options 50, 51, and 52 as discussed in relation to an unsuccessful completion of the foreign travel simulator page are also presented in order for the user 6 to finish.

The present invention addresses the problems relating to users employing on-line commerce systems for compound transactions and in particular to those relating to self-service kiosks. The provision of links to websites that relate to on-line trainer facilities and simulators allow users to increase their familiarity with individual self-service kiosks. The associated increased confidence obtained by users makes them more likely to employ such self-service kiosks, while reducing their concerns with regards over spending due to mistaken multiple purchases on their credit cards or credit card fraud by third parties.

Where the term credit card is used, it will be recognised by one skilled in the art that the same use may be made of a debit card, electronic cash card, electronic payment card, electronic wallet or personal identifier device.

The invention extends to computer programs in the form of source code, object code, code intermediate sources and object code (such as in a partially compiled form), or in any other form suitable for use in the implementation of the invention. Computer programs may be standalone applications, software components or plug-ins to other applications. Computer programs may be web pages. Computer programs may be embodied on a carrier, being any entity or device capable of carrying the computer program: for example, a storage medium such as ROM or RAM, optical recording media such as CD-ROM or magnetic recording media such as floppy discs. The carrier may be a transmissible carrier such as an electrical or optical signal conveyed by electrical or optical cable, or by radio or other means. Computer programs may be provided for download across the Internet from a server. Computer programs may also be embedded in an integrated circuit.

Further modifications and alterations may be made within the scope of the invention herein disclosed.

What is claimed is:

1) A method of training a user of a self-service kiosk, the method comprising the steps of:
providing a self-service kiosk for providing a service to a user;
on or adjacent to the self-service kiosk, providing the address of an online training facility; and
providing at said address an online training facility instructing the user in the use of said self-service kiosk.

2) The method of training a user of claim 1 wherein said service to a user requires said user to enter information or make selections relating to the service provided.

3) The method of training a user of claim 2 wherein said information is provided by said user entering information in a predetermined format in one or more fields.

4) The method of training a user of claim 2 wherein said information is provided or selections are made by said user selecting from one or more options as provided by the trainer facility.

5) The method of training a user of claim 1 wherein said address of the online training facility is provided in the form of a removable printed document.

6) The method of training a user of claim 5 wherein said removable printed document is a business card.

7) The method of training a user of claim 5 wherein said removable printed document is printed when required by said self-service kiosk.

8) The method of training a user of claim 2 wherein the online trainer facility instructs a user by the steps of:
providing an introduction that outlines the procedure to be followed in order to complete said trainer;
simulating the service to the user provided by said self-service kiosk; and
providing a guide to entering said information relating to said service to the user provided by said self-service kiosk.

9) The method of training a user of claim 8 wherein the guide to entering said information comprises a pointer and a prompt that informs the user as to the correct format and procedure for entering said information.

10) The method of training a user of claim 8 wherein an error message is provided if incorrect information is entered by said user into the simulation.

11) The method of training a user of claim 8 further comprising the step of allowing the user, upon completion of a training session, to access an online address corresponding to an associated simulator.

12) The method of training a user of claim 8 further comprising the step of providing a visual simulation of self-service kiosk peripherals other than a display.

13) A method of training a user of a self-service kiosk, the method comprising the steps of:
providing a self-service kiosk for providing a service to a user;
on or adjacent to the self-service kiosk, providing the address of an online simulator; and
providing at said address an online simulator simulating the function of said self-service kiosk.

14) The method of training a user of claim 13 wherein said service to a user requires said user to enter information or make selections relating to the services provided.

15) The method of training a user of claim 14 wherein said information is provided by said user entering information in a predetermined format in one or more fields.

16) The method of training a user of claim 14 wherein said information is provided or selections are made by said user selecting from one or more options as provided by the simulator.

17) The method of training a user of claim 13 wherein said address of the online training facility is provided by a removable printed document.

18) The method of training a user of claim 17 wherein said removable printed document is a business card.

19) The method of training a user of claim 17 wherein said removable printed document is a receipt printed when required by said self-service kiosk.

19) The method of training a user of claim 13 further comprising the step of providing a visual simulation of self-service kiosk peripherals other than a display.
